(19) United States
(12) Patent Application Publication
(10) Pub. No.: US 2010/0192071 A1
(43) Pub. Date: Jul. 29, 2010

(54) CLIENT PROGRAM, TERMINAL, METHOD, SERVER SYSTEM AND SERVER PROGRAM

(75) Inventor: Atsushi Noguchi, Chiba (JP)

Correspondence Address: HOFFMAN WARNICK LLC, 75 STATE ST, 14 FL, ALBANY, NY, 12207, US

(73) Assignee: INTERNATIONAL BUSINESS MACHINES CORPORATION, Armonk, NY (US)

(21) Appl. No.: 12/694,424

(22) Filed: Jan. 27, 2010

(30) Foreign Application Priority Data
Jan. 28, 2009 (JP) 2009-17290

(51) Int. Cl. G06F 3/048; G06F 15/16

(52) U.S. Cl. 715/753; 715/760; 709/217

(57) ABSTRACT

A computer-implemented client program that is downloaded and executed by computer terminals to synchronize display screen images of web browsers in the terminals. The client program causes the terminals to function as: an event transmitting unit that transmits an event to a server apparatus, where the event has occurred on a first terminal; an event receiving unit that receives a different event through the server apparatus, where the event has occurred on a different terminal; and a screen-image updating unit that updates a display screen image shown on the first terminal to a screen image in accordance with the different event received through the server apparatus. A computer terminal, computer-implemented method, computer-implemented server system and computer-implemented server program is provided for executing the computer-implemented client program.

### CROSS-REFERENCE TO RELATED APPLICATIONS

This application claims priority under 35 U.S.C. §119 to Japanese Patent Application No. 2009-17290 filed Jan. 28, 2009, the entire contents of which are incorporated by reference herein.

### BACKGROUND OF THE INVENTION

1. Field of the Invention

The present invention relates to a computer-implemented client program that is downloaded and then executed by computer terminals, and also relates to a computer terminal, a computer-implemented method, a computer-implemented server system and a computer-implemented server program for the computer-implemented client program.

2. Description of the Related Art

When web content (for example, an HTML file) of a uniform resource locator (URL) is accessed from two web browsers, an operation performed by a user of one of the web browsers on a screen image displayed by the web browser is completed exclusively within the certain web browser. Accordingly, one operation performed on one of the web browsers cannot cause multiple web browsers to display a synchronous transition of web content screen images. That is, only performing the same operation independently on two web browsers can change the screen images operating on the respective web browsers to the same web content.

In addition, virtual network connection (VNC), Remote Desktop (a function attached to Microsoft Windows (registered trademark)), and the like are known as utility tools for sharing operational screen images of computers. However, since those utility tools transmit and receive screen images in the form of image data, heavy loads are placed on networks, and it takes a long time to redraw the images.

Additionally, those utility tools cannot be used unless applications exclusive thereto are installed on the operation system. Accordingly, even if a function equivalent to one of those utility tools is applied to a web browser, the user has to bear a great burden because a long processing time is required for drawing an image and because an existing web browser should be replaced.

### SUMMARY OF THE INVENTION

According to one embodiment of the present invention, a computer-implemented client program that is downloaded and then executed by a plurality of computer terminals synchronizes display screen images of web browsers in the respective terminals. The client program causes each terminal to function as: an event transmitting unit that transmits an event to a computer-implemented server apparatus, where the event has occurred on a first terminal; an event receiving unit that receives a different event through the server apparatus, where the different event has occurred on a different terminal of the plurality of computer terminals; and a screen-image updating unit that updates a display screen image shown on the first terminal to a screen image according to the different event received through the server apparatus.

According to another embodiment of the present invention, a computer terminal that executes a web browser includes: a computer client-program executing unit that is implemented when the client program is downloaded from a computer-implemented server apparatus and then executed by the terminal, where the client program synchronizes display screen images of web browsers in a plurality of computer terminals. The client-program executing unit includes: an event transmitting unit that transmits to the server apparatus a first event that has occurred on the first terminal; an event receiving unit that receives a different event through the server apparatus, where the different event has occurred on a different terminal of the plurality of computer terminals; and a screen-image updating unit that updates a display screen image shown on the first terminal to a screen image according to the different event received through the server apparatus.

According to still another embodiment of the present invention, a computer-implemented method of synchronizing display screen images of web browsers in a plurality of computer terminals is provided. The method includes: transmitting an event that has occurred on a first terminal of the plurality of computer terminals to a computer-implemented server apparatus, where the event is transmitted by the first terminal; receiving the event through the server apparatus, wherein the event is received by a different terminal of the plurality of computer terminals; and updating a display screen image shown on the different terminal to an updated screen image according to the event received through the server apparatus, wherein the display screen image is updated by the different terminal.

According to yet another embodiment of the present invention, a computer-implemented server system that synchronizes display screen images of respective web browsers in a plurality of computer terminals includes: a program transmitting unit that transmits a computer-implemented client program in response to a request transmitted from a web browser operating on a first terminal of the plurality of computer terminals, where the client program includes a function that notifies the server system of a first event that has occurred on the first terminal; and an event transferring unit that, upon receiving the notification, (i) notifies a different terminal of the first event, (ii) and updates a display screen image of a web browser in the different terminal in accordance with the first event.

According to a further embodiment of the present invention, a computer-implemented server program is provided for causing a computer to function as a computer-implemented server system that synchronizes display screen images of respective web browsers in a plurality of computer terminals. The server program executes the steps of: transmitting a computer-implemented client program to a first terminal of the plurality of computer terminals in response to a request transmitted from a web browser operating on the first terminal, where the client program is transmitted by a computer-implemented server apparatus, and the client program has a function that notifies the server apparatus of an event that has occurred on the first terminal; and notifying the different terminal, by the server apparatus, of the event and updating, by the server apparatus, the display screen image in accordance with the event, where the notifying and updating by the server apparatus is executed upon receiving a notification of the event from the first terminal.

### BRIEF DESCRIPTION OF THE DRAWINGS

FIG. 1 shows a configuration of a computer system 10 according to embodiments of the present invention.

FIG. 2 shows configurations of web content and a web browser according to embodiments of the present invention.

FIG. 3 shows functional configurations of a computer-implemented server apparatus 20 and each of the computer terminals 30 according to embodiments of the present invention.

FIG. 4 shows one example of a processing flow in a case where the terminals 30 access a web page provided by the server apparatus 20 according to embodiments of the present invention.

FIG. 5 shows functional configurations of the server apparatus 20 and each of the terminals 30 according to a first modification of an embodiment of the present invention.

FIG. 6 shows functional configurations of the server apparatus 20 and each of the terminals 30 according to a second modification of an embodiment of the present invention.

FIG. 7 shows one example of a processing flow in a case where the terminals 30 access a web page provided by the server apparatus 20 according to embodiments of the present invention.

FIG. 8 shows functional configurations of the server apparatus 20 and each of the terminals 30 according to a third modification of an embodiment of the present invention.

FIG. 9 shows one example of a hardware configuration of a computer 1900 according to embodiments of the present invention.

### DETAILED DESCRIPTION OF PREFERRED EMBODIMENTS

It will be readily understood that embodiments of the present invention, as generally described and illustrated in the figures herein, may be arranged and designed in a wide variety of different configurations in addition to the described preferred embodiments. Thus, the following detailed description of the embodiments of the present invention, as represented in the figures, is not intended to limit the scope of the invention, as claimed, but is merely representative of selected preferred embodiments of the invention. The following description is intended only by way of example, and illustrates certain selected preferred embodiments of the invention as claimed herein.

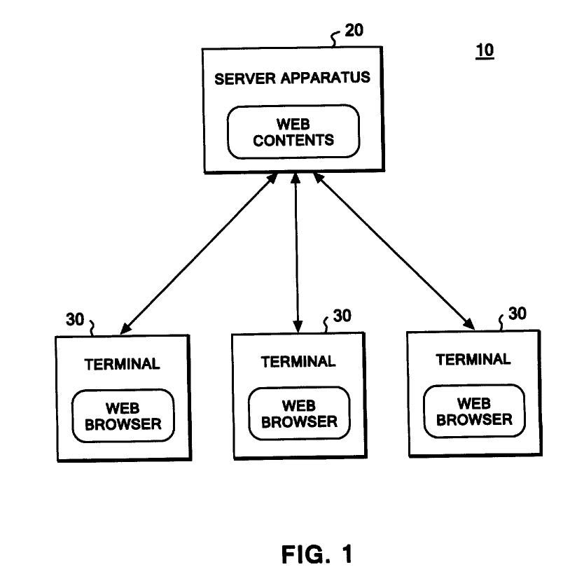

Referring to FIG. 1, a computer-implemented system 10 according to an embodiment of the present invention includes a computer-implemented server apparatus 20 and computer terminals 30. The server apparatus 20 provides web content to the terminals 30. In one example, the server apparatus 20 provides web content thereto through a computer network, where the web content take the form of HTML files.

The respective terminals 30 execute web browsers. The terminals 30 that has executed a corresponding the web browser acquires web content from the server apparatus 20 and then executes the web content in accordance with an operation of a user thereof, thereby showing information provided by this web content. In one example, the terminal 30 downloads a web page, and shows the web page on the display screen of the web browser.

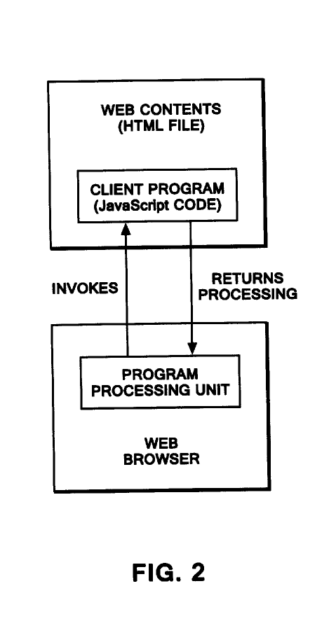

FIG. 2 shows configurations of web content and each web browser according to the embodiment. The web content includes a computer-implemented client program. The client program is downloaded and then executed by each of the terminals 30, and is operable to synchronize display screen images of the web browsers in the respective terminals 30.

The client program is a program written in code, such as JavaScript code, executable by a web browser. The client program in one example is inserted into a web page taking the form of, for example, an HTML file. Additionally, in one example, the client program is created by a provider of the web content.

Each of the web browsers downloads and executes the client program, thereby causing a corresponding terminal 30 to function as a program processing unit. The program processing unit invokes the client program, and receives a result of processing performed by the client program.

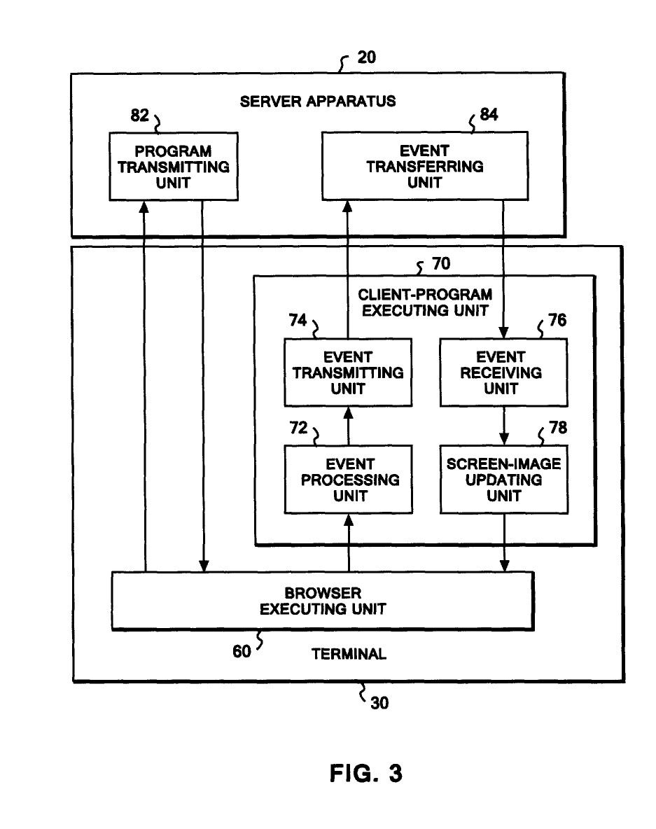

FIG. 3 shows functional configurations of the server apparatus 20 and each of the terminals 30. The terminal 30 includes a browser executing unit 60 and a client-program executing unit 70.

The browser executing unit 60 is implemented by causing the terminal 30 to execute the web browser. The browser executing unit 60 acquires web content from the server apparatus 20, and shows information provided by this web content on a display screen image of the web browser. Furthermore, the browser execution unit 60 causes the terminal 30 to execute the client program contained in the acquired web content.

The client-program executing unit 70 is implemented by causing the terminal 30 to execute the client program contained in the web content. The client-program executing unit 70 includes an event processing unit 72, an event transmitting unit 74, an event receiving unit 76 and a screen-image updating unit 78.

The event processing unit 72 acquires an event that has occurred on the terminal 30. In one example, the event processing unit 72 acquires an event that occurs in accordance with an operation performed by a user on a display screen image of the web browser. The event processing unit 72 acquires, for example, a button operation, a key operation, a character inputting operation or a pointer moving operation as the event that occurs in accordance with an operation performed by the user on a display screen image of the web browser.

Furthermore, in another example, the event processing unit 72 generates a message that makes a notification that the acquired event has occurred. Additionally, the event processing unit 72 may incorporate content and a parameter of the acquired event in the message. For example, when the character inputting operation occurs as the event, the event processing unit 72 incorporates character codes of inputted characters as the parameter in the message. For example, when the pointer moving operation occurs as the event, the event processing unit 72 incorporates coordinates of the pointer as the parameter in the message.

The event transmitting unit 74 transmits an event to the server apparatus 20, where the event has occurred on the terminal 30. In one example, the event transmitting unit 74 transmits an event to the server apparatus 20, where the event has been formed into a message by the event processing unit 72.

The event receiving unit 76 receives events through the server apparatus 20, where the event has occurred on the terminal 30 or another one of the terminals 30. In one example, the event receiving unit 76 receives events that has been formed into a message.

The screen-image updating unit 78 updates a display screen image shown one each of the terminals 30 to screen images corresponding to events having occurred on the terminal 30 and another one of the terminals 30 that are received through the server apparatus 20. In one example, the screen-image updating unit 78 provides content and a parameter of an event to the browser executing unit 60, and thereby updates a display screen image of the web browser to a screen image corresponding to the event, the content and parameter having been incorporated in a message received by the event receiving unit 76.

Accordingly, the browser executing unit 60 can set a display screen image shown on the terminal 30 to a display screen images shown on another one of the terminals 30. For example, the browser executing unit 60 can show characters on display screen images of the web browsers of a first terminal 30 and all of the other terminals 30, where the characters have been inputted to the web browser of the first terminal 30. Additionally, for example, the browser executing unit 60 can set a display position of a pointer of the web browser of the first terminal 30 as the display position of pointers in display window images in the first terminal 30 and all of the other terminals 30.

The server apparatus 20 includes a program transmitting unit 82 and an event transferring unit 84. In response to a request transmitted from a web browser operating on each of the terminals 30, the program transmitting unit 82 transmits a client program to the terminal 30, where the client program has a function that notifies the server apparatus 20 of an event having occurred on the terminal 30. More specifically, the program transmitting unit 82 transmits the client program that causes each of the terminals 30 to function as the event processing unit 72, the event transmitting unit 74, the event receiving unit 76 and the screen-image updating unit 78.

Upon receiving the notification of an event from the first terminal 30, the event transferring unit 84 notifies the first terminal 30 and the other terminals 30 of the event, and causes the display screen images of the web browsers in the first terminal 30 and the other terminals 30 to be updated in accordance with the event. In one example, the event transferring unit 84 receives a message notifying the server apparatus 20 of an occurrence of an event from a first one of the terminals 30, and transfers the received message to the first terminal 30 and the other terminals 30.

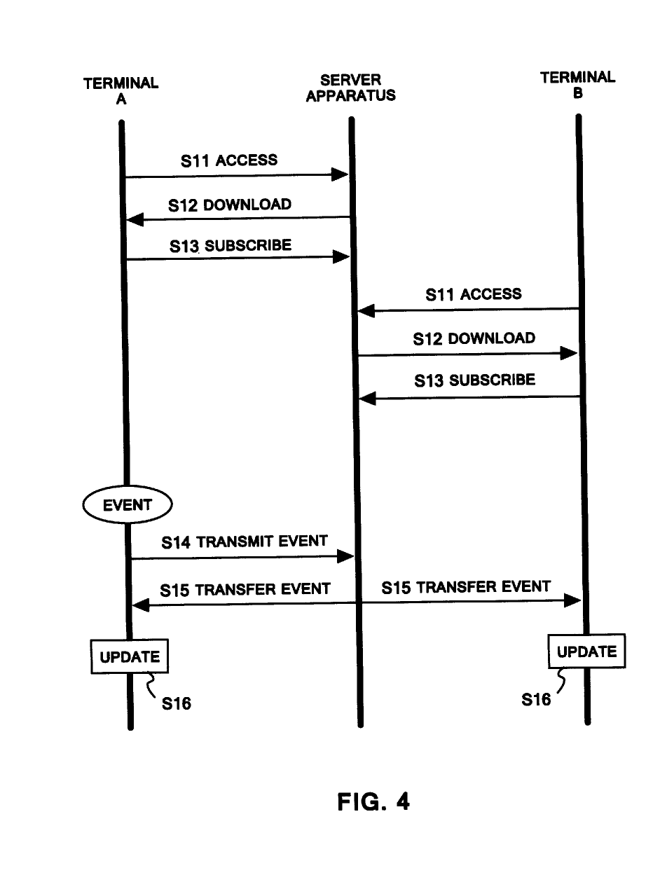

FIG. 4 shows one example of a processing flow in a case where the terminals 30 access a web page provided by the server apparatus 20. First, the browser executing unit 60 of the first terminal 30 accesses the server apparatus 20 (S11), and downloads the web page (S12). This web page includes the client program. Accordingly, the browser executing unit 60 of the first terminal 30 can download the client program at the same time.

Subsequently, the browser executing unit 60 of the first terminal 30 executes the downloaded client program. Thus, the first terminal 30 can implement therein the client-program executing unit 70.

Subsequently, the client-program executing unit 70 of the first terminal 30 subscribes to the server apparatus 20 (S13). In one example, the client-program executing unit 70 registers a callback function invoked upon receiving an event. Thus, upon receiving an event from one of the terminals 30, the server apparatus 20 can invoke the event receiving units 76 of the respective terminals 30. Additionally, the other terminals 30 other than the first terminal 30 also execute the above processing from S11 to S13.

Subsequently, upon occurrence of the event in the first terminal 30, the browser executing unit 60 of the first terminal 30 invokes the event processing unit 72. The event processing unit 72 acquires content and a parameter of the event having occurred, from the browser executing unit 60. Subsequently, the event processing unit 72 generates a message indicating the content and parameter of the event, and then invokes the event transmitting unit 74. Then, the event transmitting unit 74 transmits the event formed into the message by the event processing unit 72, to the event transferring unit 84 of the server apparatus 20 (S14).

Subsequently, upon receiving the event from the first terminal 30, the event transferring unit 84 of the server apparatus 20 transfers the received event to all the terminals 30 that have subscribed to the server apparatus 20 (S15). In one example, upon receiving the event from the first terminal 30, the event transferring unit 84 of the server apparatus 20 invokes the event receiving units 76 of the first terminal 30 and the other terminals 30.

Subsequently, upon receiving the event, the event receiving units 76 of the first terminal 30 and the other terminals 30 invoke the screen-image updating units 78. The screen-image updating units 78 update display screen images shown on web pages to a screen image corresponding to the content and parameter of the event having been transferred by the server apparatus 20 (S16). Then, thereafter, each of the terminals 30 executes the above processing from step S14 to step S16 every time an event occurs in one of the terminals 30.

By means of the server apparatus 20 and terminals 30 as described above, the display screen images of the web browsers of the terminals 30 can be synchronously updated in response to an occurrence of an event in the first terminal 30. Furthermore, by means of the server apparatus 20 and terminals 30 as described above, a message indicating a content and a parameter of an event having occurred in a web browser is transferred, whereby the amount of exchanged information can be reduced, and the period of time required for updating the screen images can be reduced. Furthermore, by means of the server apparatus 20 and terminals 30 as described above, the client program is downloaded and executed by existing web browsers without having exclusive applications installed into the terminals 30, whereby the burden on the user can be reduced.

The server apparatus 20 and the terminals 30 may be configured to synchronously update the display screen images with respect to previously specified events only, and not to synchronously update the display screen images with respect to events other than the specified events. In this case, when one of the specified events occurs, a first one of the terminals 30 transfers the event to the other terminals 30 through the server apparatus 20, and, when one of the unspecified events occurs, the first terminal 30 does not transfer the event to the other terminals 30 through the server apparatus 20 and updates a display screen image of the web browser of the first terminal 30 only.

In this case, the server apparatus 20 and the terminals 30 may be configured to specify a synchronously updated event for the individual terminals 30. For example, the first terminal 30 may cause a user to select events to be synchronously updated prior to the subscription, and may subscribe to the server apparatus 20 so that the event receiving unit 76 can be invoked only with respect to the selected events. Thus, when one of events selected in another one of the terminals 30 has occurred, the server apparatus 20 is capable of transferring the event to the first terminal 30, and, when any one of the event unselected in another one of the terminals 30 has occurred, the server apparatus 20 is not capable of transferring the event to the first terminal 30.

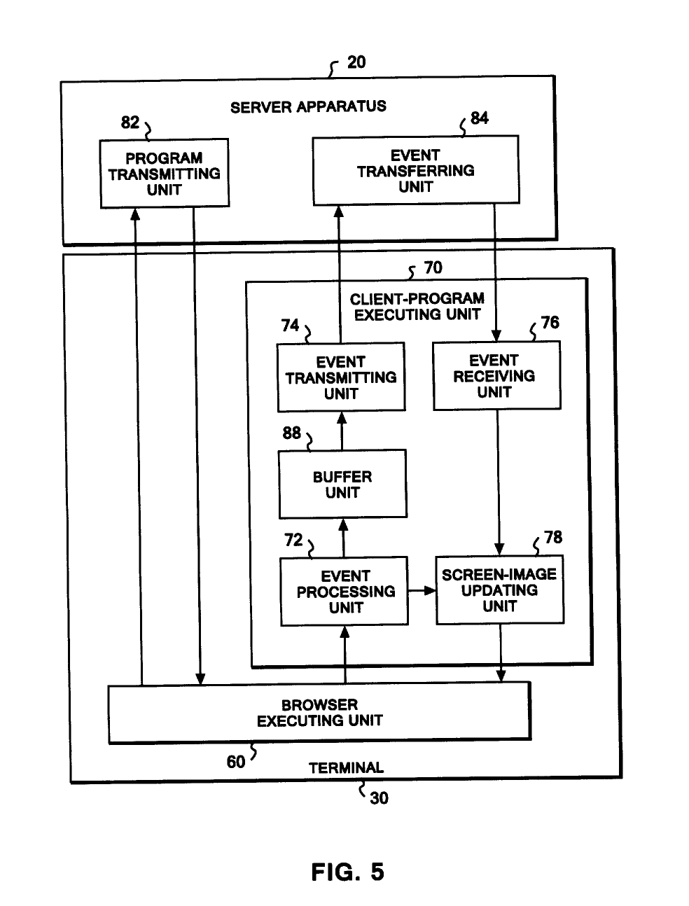

FIG. 5 shows functional configurations of the server apparatus 20 and each of the terminals 30 according to a modification of the embodiment of the present invention. The server apparatus 20 and the terminal 30 according to this modification have substantially the same configurations and functions as the server apparatus 20 and each of the terminals 30 according to the embodiment shown in FIG. 2. Therefore, the same reference numerals are used for those configurative and functional members that are substantially the same as the members shown in FIG. 2, and explanations of the modification are omitted below except for differences thereof.

The client-program executing unit 70 according to this modification further includes a buffer unit 88. The buffer unit 88 stores therein one or more events having occurred on the terminal 30. In one example, the buffer unit 88 stores therein messages generated by the event processing unit 72.

Upon receiving an instruction from the user of the terminal 30, the event transmitting unit 74 transmits to the server apparatus 20 the one or more events stored in the buffer unit 88, where the instruction instructs the synchronization of display screen images of web browsers in the other terminals 30 with a display screen image of a web browser in the terminal 30. By means of the terminals 30 as described herein according to this modification, the display screen images of the other terminals 30 can be updated at the timing desired by the user.

Additionally, in this modification, the screen-image updating unit 78 acquires an event having occurred on the terminal 30, and causes display screen images of web browsers to be updated to a screen image corresponding to the acquired event. In this case, the event transmitting unit 74 associates identification information with the event having occurred on the terminal 30, and then transmits the event to the server apparatus 20. The identification information is information identifying at least one of the terminals 30 and a web browser operating on the terminal 30 from the other terminals 30 and web browsers of the other terminals 30.

The event receiving unit 76 simultaneously receives events along with identification information associated with the respective events, where the events have occurred on the terminal 30 and the other terminals 30. Then, the screen-image updating unit 78 acquires an event associated with identification information that does not agree with the identification information, where the identification information identifies at least one of the terminal 30 and the web browser operating on the terminal 30, and updates a display screen image of the web browser to a screen image corresponding to the acquired event.

Thereafter, the server apparatus 20 and each of the terminals 30 according to the modification can update a screen image without involving the server apparatus 20 with respect to an event having occurred on the terminal 30. Accordingly, the server apparatus 20 and the terminal 30 according to the modification can enhance operability as a result of a response time from the occurrence of the event to the update of the screen image.

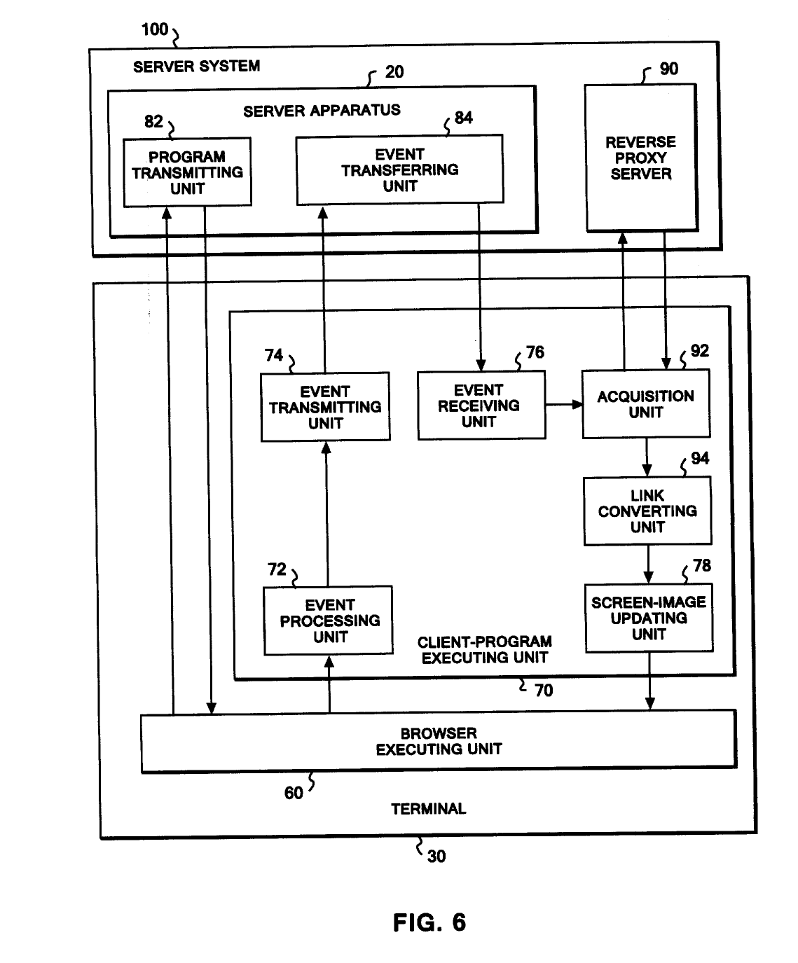

FIG. 6 shows functional configurations of the server apparatus 20 and each of the terminals 30 according to a second modification of this embodiment of the present invention. The server apparatus 20 and the terminal 30 according to this modification have substantially the same configurations and functions as the server apparatus 20 and each of the terminals 30 according to this embodiment that are shown in FIG. 2. Therefore, the same reference numerals that are used for the configurative and functional members are substantially the same as those members shown in FIG. 2, and explanations of the second modification are omitted below except for differences thereof.

The computer system 10 according to this modification includes the terminals 30 and a computer-implemented server system 100. The server system 100 includes the server apparatus 20, and a reverse proxy server 90 in the same domain as the server apparatus 20.

The reverse proxy server 90 receives an acquisition request from one of the terminals 30, where the acquisition request requests the acquisition of web content at a linked address. The reverse proxy server 90, on behalf of a web browser of the terminal 30 having transmitted the acquisition request, acquires the web content at the linked address from an external server apparatus, and transmits the web content to the terminal 30. Through the reverse proxy server 90 as described herein, a web content at an address in a domain different from that of the server apparatus 20 can be provided to the terminal 30 having accessed an address in the same domain as that of the server apparatus 20.

The client-program executing unit 70 according to this modification further includes an acquisition unit 92 and a link converting unit 94. The acquisition unit 92 provides the linked address, which is an address of the external server, and the acquisition request to the reverse proxy server 90, and acquires the web content at the linked address through the reverse proxy server 90.

Through the link converting unit 94, code operable to specify a linked address in the web content that has been acquired by the acquisition unit 92 is converted into code operable to acquire web content at the linked address by invoking the event transmitting unit 74. In this case, by the link converting unit 94, the code operable to acquire the web content at the linked address is provided as code operable to invoke the acquisition unit 92.

Additionally, in this modification, the screen-image updating unit 78 updates a display screen image shown on the terminal 30 to a screen image corresponding to the web content obtained by the conversion performed by the link converting unit 94. Additionally, the event transmitting unit 74 is invoked in response to selection of a link by the user in the web content, and the event transmitting unit 74 notifies, through the server apparatus 20, the other terminals 30 that the link has been selected. Upon receiving through the server apparatus 20 notification that the link has been selected, the event receiving unit 76 on another terminal 30 invokes the acquisition unit 92.

Additionally, in this modification, the program transmitting unit 82 transmits a client program in response to a request transmitted from a web browser operating on each of the terminals 30, the client program causing each of the terminals 30 to function as the event processing unit 72, the event transmitting unit 74, the event receiving unit 76, the acquisition unit 92, the link converting unit 94 and the screen-image updating unit 78.

Furthermore, the program transmitting unit 82 transmits web content to the respective terminals 30, where the web content contains code to be executed in response to the selection of a link, and the code is operable to acquire web content at a linked address by invoking the event transmitting unit 74. In this case, the code operable to acquire the web content at the linked address is provided as the code operable to invoke the acquisition unit 92.

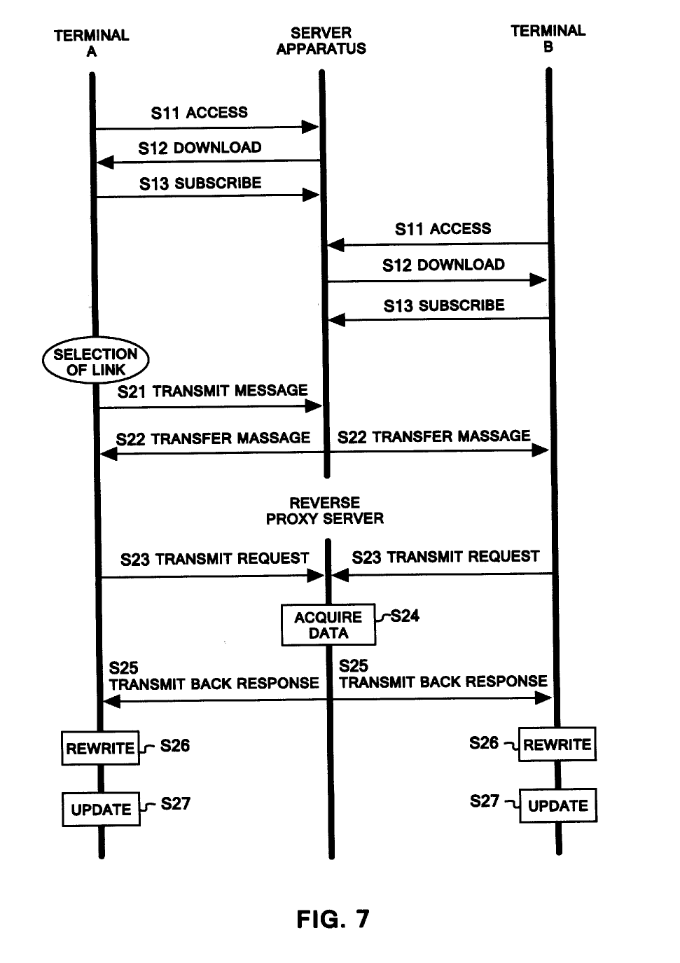

FIG. 7 shows one example of a processing flow in a case where the terminals 30 access a web page provided by the server apparatus 20. First, each the terminal 30 executes processing from steps S11 to S13 shown in FIG. 4.

Here, in a web page downloaded by the terminal 30 from the server apparatus 20 in step S12, code operable to acquire web content at a linked address by invoking the event transmitting unit 74 is contained as the code to be executed in response to selection of a link. In this case, the code operable to acquire the web content at the linked address is provided as the code operable to invoke the acquisition unit 92.

In one example, the following code is written in a web page according to this example: <a href=“javascript:sendEvent(‘loadHTMLFile’,‘http://www.abcdef.com’)” link to abcdef </a>.

This code is written in JavaScript, which is executed when the user selects a text “link to abcdef” shown on the web page. In that code, “send Event( )” represents the code operable to invoke the event transmitting unit 74.

In that code, “‘loadHTMLFile’,‘http://www.abcdef.com’” represents code operable to acquire web content from an “abcdef site” by invoking the acquisition unit 92. “loadHTMLFile” represents the code operable to invoke the acquisition unit 92. “http://www.abcdef.com/” is an argument given to the acquisition unit 92, and represents a linked address.

Once the user selects such a link in a web page in a first one of the terminals 30, the browser execution unit 60 invokes the event processing unit 72. The event processing unit 72 of the first terminal 30 generates a message and thereby invokes the event transmitting unit 74, where the message indicates that such a link in a web page has been selected. Then, the event transmitting unit 74 of the first terminal 30 transmits the message generated by the event processing unit 74 to the event transferring unit 84 of the server apparatus 20 (S21).

Subsequently, upon receiving the message from the first terminal 30, the event transferring unit 84 of the server apparatus 20 transfers the received message to all the terminals 30 that have subscribed to the server apparatus 20 (S22). In one example, upon receiving the message from the first terminal 30, the event transferring unit 84 of the server apparatus 20 invokes the event receiving units 76 of the first terminal 30 and the other terminals 30.

Subsequently, upon receiving the message, each of the event receiving units 76 of the first terminal 30 and the other terminals 30 invokes the acquisition unit 92 with the linked address shown in the message being specified. In this example, the event receiving unit 76 invokes a function “loadHTMLFile” that implements the acquisition unit 92 by using, as an argument, “http://www.abcdef.com/”, which is the linked address.

Subsequently, each of the acquisition units 92 of the first terminal 30 and the other terminals 30 transmits a request to the reverse proxy server 90, where the request is for the acquisition of data such as the web page at the specified linked address (S23). Thereafter, the reverse proxy server 90 that has received the request accesses the linked address specified by the request, and acquires the requested data (S24). Then, the reverse proxy server 90 transmits back a response containing the acquired data to each of the acquisition units 92 of the first terminal 30 and the other terminals 30 (S25).

In one example, upon first receiving from the first terminal 30, the request requesting acquisition of the data such as a web page at the specified linked address, the reverse proxy server 90 acquires the linked data from an external server apparatus at the linked address, and caches the data. Then, after the access for the first terminal 30 and upon receiving from one of the other terminals 30, the request requesting acquisition of the data at the linked address, the reverse proxy server 90 transmits back thereto the cached data. Thus, the reverse proxy server 90 can efficiently acquire the data from the external server apparatus.

Subsequently, upon receiving the response from the reverse proxy server 90, each of the acquisition units 92 of the first terminal 30 and the other terminals 30 invokes the link converting unit 94 thereof. Through each link converting unit 94 of the first terminal 30 and the other terminals 30, code operable to specify a linked address in the web page acquired by the acquisition unit 92 is converted into code operable to acquire the data (such as a web page) at the linked address (S26) by invoking the event transmitting unit 74. In this case, through the link converting unit 94, the code operable to acquire the data at the linked address is provided as the code operable to invoke the acquisition unit 92.

For example, suppose the following code operable to specify a linked address is written in the web page acquired by the acquisition unit 92, where the code represents an address to which a display screen image of a web browser should transition when the user selects a text “link to ghijkl”: <a href=“http://www.ghijkl.com/”)> link to ghijkl </a>.

In one example, the link converting unit 94 converts the code as described above into the following code: <a href=“javascript:sendEvent(‘loadHTMLFile’,‘http://www.ghijkl.com/’)” link to ghijkl </a>.

This code represents code written in JavaScript, which is executed when the user selects a text “link to ghijkl” shown on the web page. In that code, “sendEvent( )” represents the code operable to invoke the event transmitting unit 74.

In that code, “‘loadHTMLFile’,‘http://www.ghijkl.com/’” represents code operable to acquire web content from an “ghijkl site” by invoking the acquisition unit 92. “loadHTMLFile” represents code operable to invoke the acquisition unit 92. “http://www.ghijkl.com/” is an argument given to the acquisition unit 92, and represents the linked address.

After converting the code operable to specify the linked address, the link converting units 94 invoke the respective screen-image updating units 78 corresponding thereto. Then, the respective screen-image updating units 78 of the first terminal 30 and the other terminals 30 update display screen images displayed on the respective terminals 30 to a screen image corresponding to the web content obtained by the conversion performed by the link converting units 94 (S27).

By means of the server apparatus 20 and the terminals 30 according to this modification, even when data acquired from an external server apparatus is shown on a display screen image of web browsers thereof, the display screen images of web browsers of the terminals 30 can be synchronously updated. That is, by means of the server apparatus 20 and the terminals 30, even in a case where one of the web browsers is subjected to a restriction that data acquired from server apparatuses is in different domains, the data acquired from an external server apparatus can be synchronously shown on display screen images of web browsers of the terminals 30.

When the code operable to specify the linked address is selected on the first terminal 30, the acquisition unit 92 may acquire the message directly from the event processing unit 72, and then provide the request to the reverse proxy server 90. In this case, the event transmitting unit 74 associates identification information with the message, and then transmits the message to the server apparatus 20 together with the identification information. The event receiving unit 76 receives messages that are received through the server apparatus 20 from the first terminal 30 and the other terminals 30, together with the identification information associated with the messages.

Then, the acquisition unit 92 acquires messages received by the event receiving unit 76 through the server apparatus 20, where the messages are associated with identification information that does not agree with the identification information that identifies at least one of the first terminal and the web browser operating on the first terminal, and provides a request to the reverse proxy server 90. Thus, each of the terminals 30 according to this modification can enhance operability as a result of a faster response time from the selection of code operable to specify a linked address to the acquisition of data.

Additionally, each terminal 30 may further include a data transmitting unit that provides a transmission destination address to a proxy server, and then transmits data to the transmission destination address through the proxy server. In this case, by the link converting unit 94, code operable to specify the transmission destination address in web content acquired by the acquisition unit 92 is converted into code operable to transmit the web content to the transmission destination address by invoking the event transmitting unit 74. In this case, through the link converting unit 94, code operable to acquire the web content of the transmission destination address is provided as code operable to invoke the data transmitting unit.

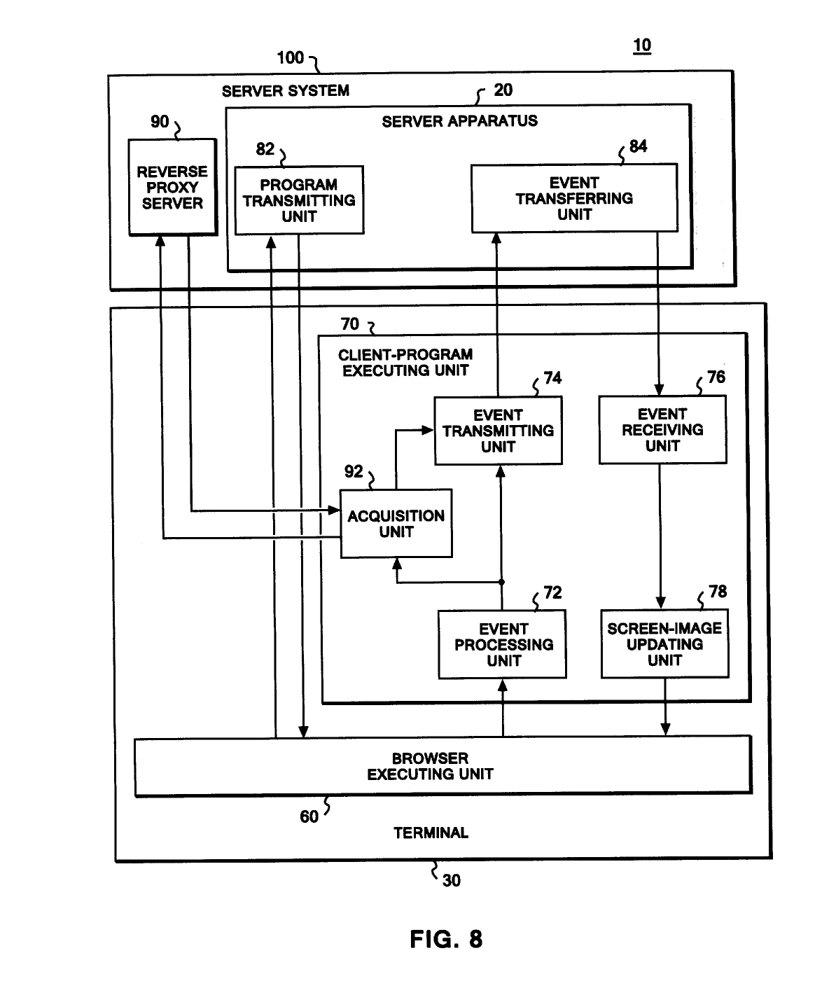

FIG. 8 shows functional configurations of the server apparatus 20 and each terminal 30 according to a third modification of this embodiment of the present invention. The server apparatus 20 and the terminal 30 according to this modification have substantially the same configurations and functions as the server apparatus 20 and the terminal 30 according to this embodiment of the present invention that are shown in FIG. 2. Therefore, the same reference numerals are used for those configurative and functional members that are substantially the same as the members shown in FIG. 2, and explanations of the third modification are omitted below except for differences thereof.

The computer system 10 according to this modification includes the terminals 30 and the server system 100. The server system 100 includes the server apparatus 20, and a reverse proxy server 90 in the same domain as the server apparatus 20. This reverse proxy server 90 shown in FIG. 8 has the same functions and configuration as the reverse proxy server 90 shown in FIG. 6.

The client-program executing unit 70 according to this modification further includes the acquisition unit 92. Upon the occurrence of an access event where access to a linked address is instructed in a display screen image of a web browser on a terminal 30, the acquisition unit 92 accesses and acquires data at the linked address.

In one example, upon the occurrence of the access event, the acquisition unit 92 is invoked by the event processing unit 72 with the linked address being specified. Then, in one example, the acquisition unit 92 acquires web content of the linked address through the reverse proxy server 90 by providing the linked address to the reverse proxy server 90.

Furthermore, in this modification, the event transmitting unit 74 associates the access event that has occurred on the terminal 30 with the data at the linked address acquired by the acquisition unit 94, and then transmits the access event to the server apparatus 20. The event receiving unit 76 receives an access event that has occurred on another terminal 30 through the server apparatus 20 together with data at a linked address associated with the access events. The screen-image updating unit 78 updates a display screen image this terminal 30 to a screen image corresponding to the access event and the data at the linked address that are received from the server apparatus 20.

By means of the server apparatus 20 and each terminal 30 according to this modification, even when there has been access to an external server apparatus on a first terminal 30, a display screen image of each of web browsers of the other terminals 30 can be synchronously updated.

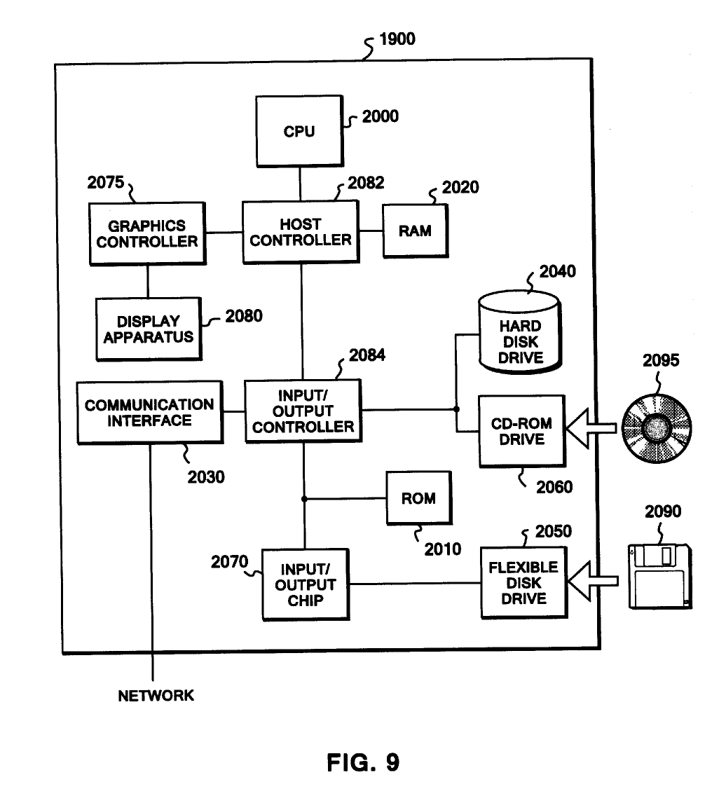

FIG. 9 is a diagram showing one example of a hardware configuration of a computer 1900 according to this embodiment of the present invention. The computer 1900 includes: a CPU peripheral section having a CPU 2000, a RAM 2020, a graphics controller 2075 and a display apparatus 2080 that are mutually connected by a host controller 2082; an input/output section having a communication interface 2030, a hard disk drive 2040 and a CD-ROM drive 2060 that are connected to the host controller 2082 through an input/output controller 2084; and a legacy input/output section having a ROM 2010, a flexible disk drive 2050 and an input/output chip 2070 that are connected to the input/output controller 2084.

The host controller 2082 connects the RAM 2020 to the CPU 2000 and the graphics controller 2075 which accesses the RAM 2020 at a high transfer rate. The CPU 2000 operates on the basis of programs stored in the ROM 2010 and the RAM 2020, thereby controlling each unit. The graphics controller 2075 obtains image data generated by the CPU 2000 or the like on a frame buffer provided in the RAM 2020, and causes the image data to be displayed on the display apparatus 2080. Alternatively, the graphics controller 2075 may contain therein a frame buffer in which image data generated by the CPU 2000 or the like is stored.

The input/output controller 2084 connects the host controller 2082 to the communication interface 2030, the hard disk drive 2040, and the CD-ROM drive 2060, which are relatively high-speed input/output devices. The communication interface 2030 communicates with other devices through a network. The hard disk drive 2040 stores a program and data used by the CPU 2000 within the computer 1900. The CD-ROM drive 2060 reads the program or the data from the CD-ROM 2095, and provides the hard disk drive 2040 with the program or the data through the RAM 2020.

Additionally, the ROM 2010, the flexible disk drive 2050 and the input/output chip 2070, which are relatively low-speed input/output devices, are connected to the input/output controller 2084. The ROM 2010 stores therein at least one boot program executed by the computer 1900 at the time of activation, a program depending on the hardware of the computer 1900, and the like. The flexible disk drive 2050 reads a program or data from a flexible disk 2090, and provides the hard disk drive 2040 with the program or the data through the RAM 2020. While connecting the flexible disk drive 2050 to the input/output controller 2084, the input/output chip 2070 connects the various input/output devices to the input/output controller 2084 through a parallel port, a serial port, a keyboard port, a mouse port and the like.

A program to be provided to the hard disk drive 2040 through the RAM 2020 is provided by a user by being stored in a recording medium such as the flexible disk 2090, the CD-ROM 2095, or an IC card. The program is read from the recording medium, installed into the hard disk drive 2040 within the computer 1900 through the RAM 2020, and executed in the CPU 2000.

The client program is downloaded into the computer 1900, executed, and causes the computer 1900 to function as the client-program executing unit 70. The client program includes an event processing module, an event transmitting module, en event receiving module and a screen image changing module. By acting on the CPU 2000 and the like, this program or respective modules cause the computer 1900 to function as the event processing unit 72, the event transmitting unit 74, the event receiving unit 76 and the screen-image updating unit 78.

By being read into the computer 1900, information processing written in this program functions as the event processing unit 72, the event transmitting unit 74, the event receiving unit 76 and the screen-image updating unit 78 which are specific means that are implemented through software and the above-described various hardware resources. Then, each terminal 30 that corresponds to the purpose of use thereof is constructed by implementing arithmetic operations or processing information that corresponds to the purpose of use of the computer 1900 by use of these specific means.

A program that is downloaded into the computer 1900 and causes the computer 1900 to function as the server apparatus 20 includes a program transmitting module and an event transferring module. By acting on the CPU 2000 and the like, this program or respective modules cause the computer 1900 to function as the program transmitting unit 82 and the event transferring unit 84.

By being read into the computer 1900, information processing written in this program functions as the program transmitting unit 82 and the event transferring unit 84 which are specific means that are implemented through software and the above-described various hardware resources. Then, a server apparatus 20 that corresponds to the purpose of use is constructed by implementing arithmetic operations or processing information that corresponds to the purpose of use of the computer 1900 by use of these specific means.

In one example, in a case where communication is performed between the computer 1900 and an external apparatus or the like, the CPU 2000 executes a communication program that has been loaded onto the RAM 2020, and instructs the communication interface 2030 to perform communication processing on the basis of a processing content written in the communication program. Controlled by the CPU 2000, the communication interface 2030: reads out data to be transmitted (hereinafter, transmission data) that is stored in a transmission buffer region or the like provided in a storage device such as the RAM 2020, the hard disk drive 2040, the flexible disk 2090 and the CD-ROM 2095, and then transmits the transmission data to a network; and writes received data into a reception buffer or the like provided on the storage device, where the reception data is received from a network. The communication interface 2030 may transfer transmitted data and received data between itself and the storage device by using a direct memory access (DMA) scheme in the above described manner, or instead, the CPU 2000 may transfer transmitted data and received data by reading out the data from the storage device or the communication interface 2030, which is an origin of the transfer, and then writing the data into the communication interface 2030 or the storage device, which is a destination of the transfer.

Additionally, the CPU 2000 loads all or any necessary part of files, databases and the like, which are stored in external storage devices, into the RAM 2020 through DMA transfer or the like, and then performs various kinds of processing on data on the RAM 2020. The external storage devices include the hard disk drive 2040, the CD-ROM drive 2060 (CD-ROM 2095) and the flexible disk drive 2050 (flexible disk 2090). Then, the CPU 2000 writes the data, on which the processing has been performed, back into the external storage devices through DMA transfer or the like. In the processing as described herein, the RAM 2020, the external storage devices and the like are collectively referred to as memories, storage units, storage devices or the like in this embodiment because the RAM 2020 can be considered as a component that temporarily retains content of the external storage devices. Various kinds of information such as various programs, data, tables, databases and the like in this embodiment are stored in the storage devices as described herein, and become subjected to information processing. Note that the CPU 2000 is also capable of retaining a part of the RAM 2020 in a cache memory, and writing and reading information into and from the cache memory. In this form also, the cache memory shares the function of the RAM 2020, and, in this embodiment, is assumed to be included in the RAM 2020, the memories and/or the storage devices unless otherwise described distinctly.

Additionally, the CPU 2000 performs various kinds of processing on data read out from the RAM 2020, and then writes the data back to the RAM 2020, the various kinds of processing being specified by instruction strings in programs and including various kinds of arithmetic operations, processing of information, conditional judgments, retrieving and replacement of information, and the like which have been described in this embodiment. For example, when evaluating a condition, the CPU 2000 determines whether each variable discussed in the embodiments of the present invention satisfies a condition, for example, whether the variable is larger, smaller, not more than, or not less than another variable or a constant. Then, if the condition holds true (or does not hold true), the CPU causes the processing to branch into a different instruction string or invokes a subroutine.

Additionally, the CPU 2000 is capable of retrieving information stored in a file, a database or the like in a storage device. For example, in a case where entries respectively having attribute values of a second attribute associated with attribute values of a first attribute are stored in the storage device, the CPU 2000: retrieves a certain entry, from the entries stored in the storage device, where the certain entry has an attribute value of the first attribute that agrees with a specified condition; and reads out an attribute value, of the second attribute, stored in the certain entry. Thus, the CPU 2000 is capable of acquiring an attribute value, of the second attribute, associated with the first attribute that satisfies a predetermined condition.

Each of the above described programs or modules may be stored in an external recording medium. As the recording medium, in addition to the flexible disk 2090 and the CD-ROM 2095, an optical recording medium such as a DVD and a CD, a magneto-optical recording medium such as an MO, a tape medium, and a semiconductor memory such as an IC card can be used. In addition, the programs may be provided to the computer 1900 through the network by use of a storage device as a recording medium, such as a hard disk or a RAM provided in a server system connected to a dedicated communication network or the Internet.

Operations, procedures, steps and stages in the computer-implemented apparatuses, systems, programs and methods shown in the scope of claims, description and drawings that are not clearly specified by use of expressions such as “before” and “prior to” can be executed in arbitrary orders unless an output from the preceding one of the processes is used in a subsequent process. Even if operational flows are described in the of claims, the description and the drawings by use of expressions such as “first,” and “subsequently,” for the sake of convenience, it does not mean that the operational flows should necessarily be executed in the orders indicated by these expressions.

What is claimed is:

1. A computer-implemented client program that is downloaded and then executed by a plurality of computer terminals to synchronize display screen images of web browsers in said plurality of computer terminals, said client program comprising a computer readable article of manufacture tangibly embodying computer readable instructions which when executed causes a computer to carry out the steps of:
transmitting, through an event transmitting unit, a first event to a computer-implemented server apparatus, wherein said first event has occurred on a first terminal of said plurality of computer terminals;
receiving, through an event receiving unit, a different event through said server apparatus, wherein said different event has occurred on a different terminal of said plurality of computer terminals; and
updating, through a screen image updating unit, a display screen image of a web browser shown on said first terminal to a screen image according to said different event received through said server apparatus.

2. The client program according to claim 1, wherein said first event occurs in response to an operation performed by a user on said display screen image.

3. The client program according to claim 1, wherein:
said receiving step further comprises receiving, through said event receiving unit, said first event, and
said updating step further comprises updating, through said screen image updating unit, said display screen image to a screen image according to said first event and said different event.

4. The client program according to claim 1, wherein said updating step further comprises updating, through said screen image updating unit, said display screen image to a screen image according to said first event or said different event.

5. The client program according to claim 4, wherein:
said transmitting step further comprises (i) associating, through said event transmitting unit, identification information with said first event, and (ii) transmitting, through said event transmitting unit, said first event to said server apparatus, wherein said identification information identifies said first terminal and said web browser,
said receiving step further comprises receiving, through said event receiving unit, said first event together with said identification information associated with said first event, and
said updating step further comprises updating, through said screen image updating unit, said display screen image to a screen image according to (i) said first event or (ii) said different event received through said server apparatus and associated with another identification information that does not agree with said identification information associated with said first event.

6. The client program according to claim 1, wherein said computer readable instructions further causes said computer to carry out the step of: storing, in a buffer unit, said first event, wherein said event transmitting unit transmits said first event stored in said buffer unit to said server apparatus.

7. The client program according to claim 6, wherein:
upon receiving an instruction from a user of said first terminal, transmitting, through said event transmitting unit, said first event stored in said buffer unit to said server apparatus, and
said instruction instructs said server apparatus to synchronize a display screen image of a web browser of said different terminal with said display image of said web browser in said first terminal.

8. The client program according to claim 1, wherein said computer readable instructions further causes said computer to carry out the steps of:
acquiring, through an acquisition unit, web content at a linked address through a reverse proxy server; and
converting, through a link converting unit, code operable to specify said linked address within said web content acquired by said acquisition unit into code operable to (i) invoke said event transmitting unit and then (ii) acquire said web content at said linked address, wherein
said updating step further comprises updating, through said screen-image updating unit, said display screen image to a screen image according to said web content resulting from said converting step,
said event transmitting unit is invoked in response to a selection of said linked address within said web content by a user, and said event transmitting unit notifies said different terminal through said server apparatus that said linked address is selected, and
said event receiving unit invokes said acquisition unit upon receiving said notification through said server apparatus.

9. The client program according to claim 8, wherein:
said acquisition unit acquires said web content at said linked address by providing said linked address to said reverse proxy server within the same domain as said server apparatus; and
said link converting unit converts code operable to acquire said web content of said linked address into code operable to invoke said acquisition unit.

10. The client program according to claim 1, wherein said computer readable instructions further causes said computer to carry out the step of:
accessing and acquiring, through an acquisition unit, data at a linked address in response to an occurrence of a first access event on said first terminal, wherein:
said first access event instructs a first access to said first linked address in said display screen image,
said event transmitting unit associates said first access event with data at said first linked address and transmits said first access event to said server apparatus,
said event receiving unit receives a different access event together with data at a linked address associated with said different access event, wherein said different access event has occurred on said different terminal, and
said screen-image updating unit updates said display screen image to a screen image according to said access event and said data at said different linked address that is received through said server apparatus.

11. A computer-implemented terminal that executes a web browser, comprising:
a computer client-program executing unit that is implemented on the condition that a computer client program is downloaded from a computer-implemented server apparatus and then executed by a first terminal, wherein said client program synchronizes display screen images of web browsers in said first terminal and a different computer terminal, wherein said client-program executing unit comprises:
an event transmitting unit that transmits a first event that has occurred on said first terminal to said server apparatus;
an event receiving unit that receives a different event through said server apparatus, wherein said different event has occurred on a different terminal; and
a screen-image updating unit that updates a display screen image shown on said first terminal to a screen image according to said different event received through said server apparatus.

12. A computer-implemented method of synchronizing display screen images of web browsers in a plurality of computer terminals, comprising the steps of:
transmitting a event that has occurred on a first terminal of said plurality of computer terminals to a computer-implemented server apparatus, wherein said event is transmitted by said first terminal;
receiving said event through said server apparatus, wherein said event is received by a different terminal of said plurality of computer terminals; and
updating a display screen image shown on said different terminal to an updated screen image according to said event received through said server apparatus, wherein said display screen image is updated by said different terminal.

13. A computer-implemented server system that synchronizes display screen images of respective web browsers in a plurality of computer terminals, said system comprising:
a program transmitting unit that transmits a computer-implemented client program in response to a request transmitted from a web browser operating on a first terminal of said plurality of computer terminals, wherein said client program includes a function that notifies said server system of a first event that has occurred on said first terminal; and
an event transferring unit that, upon receiving said notification, (i) notifies a different terminal of said plurality of computer terminals of said first event, and (ii) updates a display screen image of a web browser in said different terminal in accordance with said first event.

14. The server system according to claim 13, further comprising a reverse proxy server, wherein upon receiving from said first terminal an acquisition request that requests an acquisition of data at a linked address, said reverse proxy server acquires said data at said linked address on behalf of said web browser of said first terminal,
wherein said program transmitting unit transmits to said first terminal said client program that further includes a function by which code operable to specify a linked address within said acquired data is converted into code operable to instruct said reverse proxy server to acquire said data.

15. The server system according to claim 14, wherein
upon receiving said acquisition request for data at a linked address from one of the terminals, the reverse proxy server acquires and caches therein the data at the linked address from an external server apparatus at the linked address upon receiving said acquisition request for said data, said reverse proxy server acquires and caches therein said data at said linked address from an external server apparatus at said linked address, and
upon receiving an acquisition request for said data from said different terminal, said reverse proxy server transmits back said cached data thereto.

16. The method according to claim 12, further comprising:
transmitting a computer-implemented client program to said first terminal in response to a request transmitted from a web browser operating on said first terminal, wherein said client program is transmitted by said server apparatus, and said client program has a function that notifies said server apparatus of said event that has occurred on said first terminal; and
notifying, by said server apparatus, said different terminal of said event and updating, by said server apparatus, said display screen image in accordance with said event, wherein said notifying and said updating by said server apparatus is executed upon receiving a notification of said event from said first terminal.

17. A server program that causes a computer to function as a server system that synchronizes display screen images of respective web browsers in a plurality of terminals, the server program executes the steps according to claim 16.
